(19) United States
(12) Patent Application Publication
(10) Pub. No.: US 2016/0145841 A1
(43) Pub. Date: May 26, 2016

(54) Bathroom Fixture Having Integrated Surfactant Dispenser

(71) Applicant: Christopher Jaha, Gresham, OR (US)

(72) Inventor: Christopher Jaha, Gresham, OR (US)

(21) Appl. No.: 14/550,701

(22) Filed: Nov. 21, 2014

(51) Int. Cl. E03C 1/046; B05B 1/18

(52) U.S. Cl. CPC E03C 1/046; B05B 1/185

(57) ABSTRACT

A shower fixture operable to facilitate the blending of a surfactant into a water stream egressing therefrom. The shower fixture further includes an integrated dispenser assembly. The dispenser assembly includes a housing having an interior volume. A plurality of storage reservoirs are releasably secured to the housing proximate the upper end thereof. Disposed within the housing is a rotational valve. The rotational valve includes an outer wall that is integrally formed with a water pipe of the shower fixture and rotatable therearound. The outer wall of the valve further includes a channel with the channel having a hollow passage therethrough. A plurality of tubes are disposed within the housing and operable to couple the storage reservoirs and the valve. A plug member is further included and is mounted within the housing of the dispenser assembly.

### PRIORITY UNDER 35 U.S.C SECTION 119(E) & 37 C.F.R. SECTION 1.78

This nonprovisional application claims priority based upon the following prior United States Provisional Patent Application entitled: Dispenser for Liquid Bath Products, Application No. 61/910,591 filed Dec. 2, 2013, in the name of Christopher Jaha, which is hereby incorporated by reference for all purposes.

### FIELD OF THE PRESENT INVENTION

The present invention relates generally to bathroom fixtures, more specifically but not by way of limitation a bathroom fixture such as but not limited to a showerhead that is configured with a dispenser wherein the dispenser is operable to introduce surfactant from at least one storage vessel into the water outflow of the showerhead.

### BACKGROUND

Millions of people engage in various personal hygiene routines on a daily basis. One such exemplary routine is bathing. This is typically accomplished by either taking a shower or a bath and using a combination of water and surfactants to provide cleaning of the body.

During the aforementioned personal hygiene routine a person will typically utilize at least one type of surfactant, or soap. There are many types of soaps commercially available ranging from bar soap to liquid soap that is stored in a plastic bottle or similar vessel. Additionally, people will often use shampoo and/or conditioner, which is commercially available in liquid form.

The organization of these soaps and shampoos is typically accomplished via a variety of articles such as but not limited to shower caddies, shelving and soap dishes. The handling of the storage vessels containing the liquid soaps has shown to be cumbersome an inconvenient with often individuals dropping these vessels having the soap and/or shampoo stored therein.

Accordingly there is a need for a showerhead that includes an integrated dispenser that is operable to receive a plurality of surfactant storage vessels and wherein the dispenser fluidly couples the surfactant stored within the vessel to the water outflow propagating from the showerhead.

### SUMMARY OF THE INVENTION

It is the object of the present invention to provide a bathroom fixture that is operable to control a dispersal of liquid surfactant into the water stream flowing outward therefrom.

Another object of the present invention is to provide a bathroom fixture such as but not limited to a showerhead, wherein the showerhead includes a body that is configured to releasably receive a plurality of storage reservoirs operable to receive and retain liquid surfactant therein.

A further object of the present invention is to provide a showerhead having an integrated surfactant storage and dispensal assembly wherein the showerhead further includes a rotational valve.

An additional object of the present invention is to provide a showerhead having an integrated surfactant dispensing capabilities wherein the rotational valve is operably coupled to the plurality of storage reservoirs with a tubing network.

Yet another object of the present invention is to provide a showerhead having integrated soap dispensing wherein the rotational valve is operably coupled to a selector knob wherein the selector knob functions to provide a means for a user to select from which storage reservoir surfactant will be dispensed into the water outflow from the showerhead.

Still a further object of the present invention is to provide a showerhead having integrated surfactant dispensing wherein the rotational valve has a first position and a second position and wherein in the second position the rotational valve fluidly isolates all of the storage reservoirs from the outgoing water flow.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front diagrammatic view of an embodiment of the present invention; and

FIG. 2 is a side diagrammatic view of an embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a bathroom fixture having surfactant dispenser 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

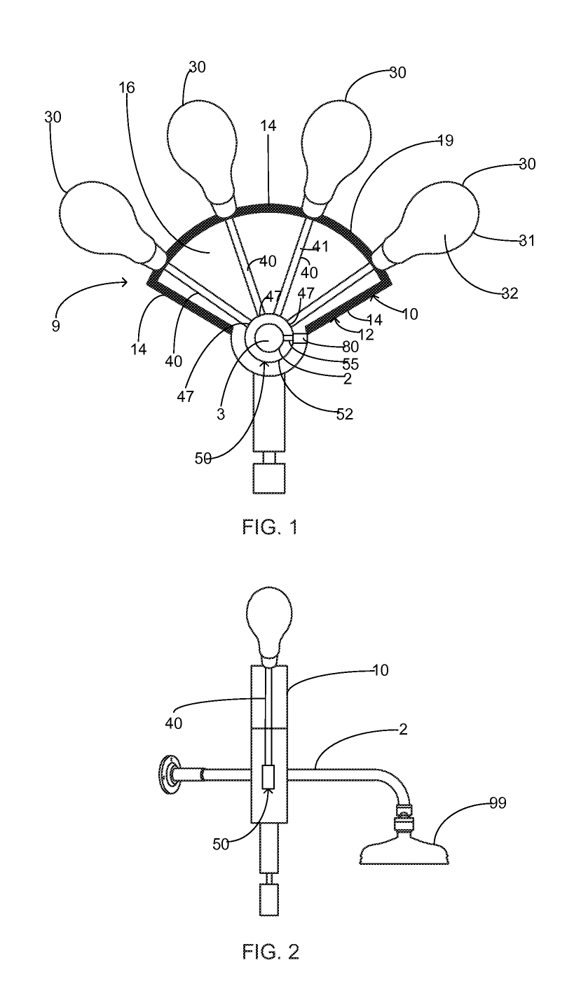

Referring in particular to FIGS. 1 and 2 herein, the bathroom fixture having surfactant dispenser 100 further includes a dispenser assembly 10 that is operably coupled to water pipe 2. The dispenser assembly 10 includes housing 12 that includes a plurality of walls 14 integrally formed to create an interior volume 16. The housing 12 is manufactured from a durable suitable material such as but not limited to metal or plastic. It is preferred that the material further be corrosion resistant due to the continued damp environment in which the bathroom fixture having surfactant dispenser 100 is exposed. The housing 12 includes upper wall 19 that is arcuate in shape. The shape of the upper wall 19 is desired as it facilitates the preferred orientation of the storage reservoirs 30 while minimizing the overall size of the housing 12. While the upper wall 19 could be planar in manner, in this configuration the width of the housing 12 proximate end 9 would have to be greater in order to obtain the required spacing of the storage reservoirs 30. As shown in particular in FIG. 1 herein, the housing 12 is surroundably mounted to the water pipe 2. It is further contemplated within the scope of the present invention that the housing 12 could be formed in numerous different shapes.

Releasably secured to the housing 12 along the upper wall 19 are a plurality of storage reservoirs 30. The storage reservoirs 30 have a wall 31 forming an interior volume 32 operable to receive and store a liquid therein. The storage reservoirs 30 are releasably secured to the housing 12 utilizing conventional techniques so as to facilitate the refilling thereof. The storage reservoirs 30 are fluidly coupled to water pipe 2 via tubes 40. Tubes 40 further include passage 41 that is hollow allowing substance disposed within the interior volume 32 of the storage reservoir 30 to pass therethrough. It is contemplated within the scope of the present invention that the storage reservoirs 30 could be formed in numerous different shapes and sizes and still accomplish the desire objective herein. Further, while four storage reservoirs 30 are illustrated herein, it is contemplated within the scope of the present invention that the bathroom fixture having surfactant dispenser 100 could have more or less than four storage reservoirs 30.

Valve 50 is disposed within housing 12 and functions to permit liquid stored within the storage reservoirs 30 to enter the passage 3 of the water pipe 2. Valve 50 is a rotational style valve that is mounted within the housing 12 utilizing suitable durable techniques. The valve 50 includes outer wall 52 that is integrally formed with water pipe 2 and being rotatable thereabout. Outer wall 52 has channel 55 journaled therethrough. The channel 55 includes passage 56 that is hollow and is operable to facilitate the fluid communication between tubes 40 and passage 3. The valve 50 includes a first position and a second position. As shown in FIG. 1 herein, in its first position, valve 50 is rotated such that the channel 55 is not aligned with any of the tube openings 47. In this position the valve 50 functions to isolate the contents of the storage reservoirs 30 from the passage 3 of the water pipe to so as to inhibit any contents from propagating into a water stream flowing through the water pipe 2. In its second position, the valve 50 is rotated such the channel 55 is substantially aligned with one of the tube openings 47. In this position, the substance disposed within the storage reservoir 30 will egress therefrom through gravitational force and enter a water stream flowing through the water pipe 2 and be carried therein and exit fixture head 99. The valve 50 is operated by a conventional knob or similar device that is not illustrated herein.

In an alternative embodiment of the valve 50 the valve 50 is further operable in a first mode and a second mode. In the first mode the valve 50 is operable to facilitate the egression of a liquid disposed into the storage reservoir 30 into passage 3 as previously described herein. In its second mode, the valve 50 facilitates the dispensing of substance disposed within the storage reservoirs 30 directly from the housing 30 such that the substance is not mixed with a water stream flowing through passage 3. It is contemplated within the scope of the present invention that the valve 50 could be operably coupled to additional tubing and spout (not illustrated herein) disposed within the housing 12 in order to provide the aforementioned functionality.

Illustrated in particular in FIG. 1 herein is plug member 80. Plug member 80 is mounted within housing 12 utilizing suitable durable means and is manufactured from a durable material such as but not limited to rubber. Plug member 80 functions to inhibit water from exiting channel 55 when the valve 50 is in its closed position.

The bathroom fixture having surfactant dispenser 100 as previously mentioned herein is surroundably mounted to water pipe 2. Water pipe 2 is operably coupled to a conventional plumbing system and includes fixture 99. While the bathroom fixture having surfactant dispenser 100 embodiment illustrated herein is that resembling a shower head fixture, it is contemplated within the scope of the present invention that the bathroom fixture having surfactant dispenser 100 could be other types of plumbing fixtures such as but not limited to sink plumbing fixtures.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A plumbing fixture that is operable to dispense a stream of water having a surfactant blended thereinto comprising:
a water pipe, said water pipe being fluidly coupled to a water source, said water pipe having a passage operable to permit water flow therethrough;
a dispenser assembly, said dispenser assembly surroundably mounted to said water pipe, said dispenser assembly including a housing, said housing having a plurality of walls forming an interior volume, said dispenser assembly operably coupled to said water pipe;
at least one storage reservoir, said at least one storage reservoir being operably coupled to said dispenser assembly, said at least one storage reservoir configured to retain a liquid substance therein;
a valve, said valve being disposed within said dispenser assembly, said valve operable to fluidly couple said storage reservoir with said water pipe, said valve having a first position and a second position said valve being rotationally mounted within said housing; and
wherein in said first position said valve is operable to fluidly couple the storage reservoir with the passage of the water pipe so as to allow a substance disposed within the storage reservoir to egress into a stream of water within said passage.

2. The plumbing fixture as recited in claim 1, and further including at least one tube, said at least one tube operably coupled intermediate said at least one storage reservoir and said valve so as to permit a substance within said at least one storage reservoir to flow into said valve.

3. The plumbing fixture as recited in claim 2, wherein said valve further includes an outer wall, said outer having a channel, said channel including a passage journaled through said outer wall, said channel operable to fluidly couple the passage of said water pipe to said at least one tube upon said valve being in said first position.

4. The plumbing fixture as recited in claim 3, wherein said housing of said dispenser assembly further includes an upper wall, said upper wall being arcuate in manner.

5. The plumbing fixture as recited in claim 4, wherein said valve further includes a first mode and a second mode, in said first mode said valve being operable to facilitate the introduction of a substance disposed within said at least one storage reservoir into a stream of water flowing through said water pipe and in said second mode said valve operable to facilitate the dispensing of a substance disposed within said at least one storage reservoir directly from said housing.

6. A bathroom plumbing fixture that is configured to dispense a water stream wherein the water stream includes a surfactant comprising:
a water pipe, said water pipe having a first end and a second end, said water pipe having a passage, said water pipe operable to have a stream of water flow through said passage;
a dispenser assembly, said dispenser assembly surroundably mounted to said water pipe intermediate said first end and said second end, said dispenser further including a housing, said housing having a plurality of walls integrally formed creating an interior volume, said housing being rigid, said housing having an upper end and a lower end;
a plurality of storage reservoirs, said plurality of storage reservoirs being releasably secured to said housing of said dispenser assembly, said plurality of storage reservoirs having an interior volume operable to store a substance therein, said plurality of storage reservoirs mounted proximate said upper end of said housing;
a plurality of tubes, said plurality of tubes having a first end and a second end, said plurality of tubes operably coupled to said plurality of storage reservoirs proximate said first end, said plurality of tubes being hollow so as to allow a substance to flow therethrough;
a valve, said valve being rotationally mounted within said interior volume of said housing, said valve operable to fluidly couple said plurality of storage reservoirs with the passage of said water pipe, said valve having a first position and a second position, said valve having an outer wall, said outer wall integrally formed with said water pipe and further being rotatable therearound, said outer wall further including a channel, said channel having a hollow passage, wherein in said second position said channel of said valve is aligned with said second end of one of said plurality of tubes; and
wherein in said first position, said valve fluidly isolates said plurality of storage reservoirs from said water pipe.

7. The bathroom plumbing fixture as recited in claim 6, and further including a plug member, said plug member being mounted within the interior volume of said housing of said dispenser assembly, said plug member operable to inhibit water from exiting said channel when said valve is in said first position.

8. The bathroom plumbing fixture as recited in claim 7, wherein said housing of said dispenser assembly further includes an upper wall, said upper wall being arcuate in manner, said plurality of storage reservoirs being releasably secured to said upper wall.

9. The bathroom plumbing fixture as recited in claim 8, wherein said plug member is rubber.

10. The bathroom plumbing fixture as recited in claim 9, wherein said valve further includes a first mode and a second mode, in said first mode said valve being operable to facilitate the introduction of a substance disposed within said at least one storage reservoir into a stream of water flowing through said water pipe and in said second mode said valve operable to facilitate the dispensing of a substance disposed within said at least one storage reservoir directly from said housing.

11. The bathroom plumbing fixture as recited in claim 10, wherein the bathroom fixture is a showerhead.

12. A bathroom shower plumbing fixture that is operable to receive and store a plurality of surfactants and subsequently dispense the surfactants into a stream of water exiting the bathroom shower plumbing fixture comprising:
a water pipe, said water pipe having a first end and a second end, said water pipe having a passage, said water pipe operable to have a stream of water flow through said passage;
a dispenser assembly, said dispenser assembly surroundably mounted to said water pipe intermediate said first end and said second end, said dispenser further including a housing, said housing having a plurality of walls integrally formed creating an interior volume, said housing being rigid, said housing having an upper end and a lower end, said housing having an upper wall that is arcuate in manner;
a plurality of storage reservoirs, said plurality of storage reservoirs being releasably secured to said upper wall of said housing of said dispenser assembly, said plurality of storage reservoirs having an interior volume operable to store a substance therein, said plurality of storage reservoirs mounted proximate said upper end of said housing;
a plurality of tubes, said plurality of tubes having a first end and a second end, said plurality of tubes operably coupled to said plurality of storage reservoirs proximate said first end, said plurality of tubes being hollow so as to allow a substance to flow therethrough;
a valve, said valve being rotationally mounted within said interior volume of said housing, said valve operable to fluidly couple said plurality of storage reservoirs with the passage of said water pipe, said valve having a first position and a second position, said valve having an outer wall, said outer wall integrally formed with said water pipe and further being rotatable therearound, said outer wall further including a channel, said channel having a hollow passage, wherein in said second position said channel of said valve is aligned with said second end of one of said plurality of tubes;
a plug member, said plug member being mounted within the interior volume of said housing of said dispenser assembly, said plug member operable to inhibit water from exiting said channel when said valve is in said first position; and
wherein in said first position, said valve fluidly isolates said plurality of storage reservoirs from said water pipe.

13. The bathroom shower plumbing fixture as recited in claim 12, wherein said valve further includes a first mode and a second mode, in said first mode said valve being operable to facilitate the introduction of a substance disposed within said at least one storage reservoir into a stream of water flowing through said water pipe and in said second mode said valve operable to facilitate the dispensing of a substance disposed within said at least one storage reservoir directly from said housing.

14. The bathroom shower plumbing fixture as recited in claim 13, wherein in said second position of said valve said channel is substantially aligned with a second end of one of said plurality of tubes.
